(19) United States
(12) Patent Application Publication
(10) Pub. No.: US 2022/0377036 A1
(43) Pub. Date: Nov. 24, 2022

(54) METHOD AND APPARATUS FOR STICKING CONVERSATION MESSAGE ON TOP FOR PROCESSING

(71) Applicant: TIANJIN BYTEDANCE TECHNOLOGY CO., LTD., TIANJIN (CN)

(72) Inventor: Zhenxing LUO, Beijing (CN)

(21) Appl. No.: 17/882,096

(22) Filed: Aug. 5, 2022

Related U.S. Application Data
(63) Continuation-in-part of application No. 17/245,278, filed on Apr. 30, 2021, now Pat. No. 11,444,895.
Application No. 17/245,278 is a continuation of application No. PCT/CN2019/127993, filed on Dec. 24, 2019.

(30) Foreign Application Priority Data
Dec. 29, 2018 (CN) 201811635513.4

(51) Int. Cl. H04L 51/216; G06F 3/04817; G06F 3/0486

(52) U.S. Cl. CPC H04L 51/216; G06F 3/04817; G06F 3/0486

(57) ABSTRACT

Disclosed are a method and apparatus for sticking a conversation message on top for processing. The method includes: detecting whether an obtained operation meets a predetermined condition when a client determines that a first conversation in a current conversation list region is in a selected state; and if so, displaying an icon of the first conversation synchronously at a predetermined position in a sticky conversation region. In this method, an icon of a conversation in a conversation list region can be displayed synchronously in a sticky conversation region through an operation meeting a predetermined condition, such that a user can process a message based on the icon in the sticky conversation region. In this way, the processing efficiency can be improved, and by displaying the conversation simultaneously in the conversation list region and the sticky conversation region, flexibility in displaying the conversation can be improved, thereby facilitating the user's operations.

### CROSS-REFERENCE TO RELATED APPLICATION

The present disclosure is a Continuation-In-Part (CIP) of U.S. application Ser. No. 17/245,278, filed on Apr. 30, 2021, which is a continuation of International Application No. PCT/CN2019/127993, filed on Dec. 24, 2019, which claims priority to Chinese Patent Application No. 201811635513.4, titled “METHOD AND APPARATUS FOR STICKING CONVERSATION MESSAGE ON TOP FOR PROCESSING”, and filed by Tianjin Bytedance Technology Co., Ltd., on Dec. 29, 2018.

### TECHNICAL FIELD

The present disclosure relates to the field of terminal device technologies, and more particularly, to a method and apparatus for sticking a conversation message on top for processing.

### BACKGROUND

Instant messaging is a popular way of communication on the Internet, and various instant messaging applications are emerging one after another. For existing instant messaging applications, all conversations with unread messages will be displayed in a conversation list at the same time. When there are many conversations with unread messages, it is of low efficiency for a user to process unread messages by a user.

### SUMMARY

The present disclosure provides a method and apparatus for sticking a conversation message on top for processing, capable of solving a problem associated with inefficiency in processing unread messages by a user with a method for processing a conversation message in the related art.

According to an embodiment of one aspect of the present disclosure, a method for sticking a conversation message on top for processing is provided. The method includes: detecting whether an obtained operation meets a predetermined condition when a client determines that a first conversation in a current conversation list region is in a selected state; and if so, displaying an icon of the first conversation synchronously at a predetermined position in a sticky conversation region.

With the method for sticking a conversation message on top for processing according to the embodiment of the present disclosure, when a client determines that a first conversation in a current conversation list region is in a selected state, it is detected whether an obtained operation meets a predetermined condition. If so, an icon of the first conversation is displayed synchronously at a predetermined position in a sticky conversation region. In this way, an icon of a conversation in a conversation list region can be displayed synchronously in the sticky conversation region through an operation meeting the predetermined condition, such that a user can process a message based on the icon in the sticky conversation region. In this way, the processing efficiency can be improved, and by displaying the conversation simultaneously in the conversation list region and the sticky conversation region, flexibility in displaying the conversation can be improved, thereby facilitating the user's operations.

According to an embodiment of another aspect of the present disclosure, an apparatus for sticking a conversation message on top for processing is provided. The apparatus includes: a detection module configured to detect whether an obtained operation meets a predetermined condition when a client determines that a first conversation in a current conversation list region is in a selected state; and a first display module configured to display an icon of the first conversation synchronously at a predetermined position in a sticky conversation region when the obtained operation meets the predetermined condition.

With the apparatus for sticking a conversation message on top for processing according to the embodiment of the present disclosure, when a client determines that a first conversation in a current conversation list region is in a selected state, it is detected whether an obtained operation meets a predetermined condition. If so, an icon of the first conversation is displayed synchronously at a predetermined position in a sticky conversation region. In this way, an icon of a conversation in a conversation list region can be displayed synchronously in the sticky conversation region through an operation meeting the predetermined condition, such that a user can process a message based on the icon in the sticky conversation region. In this way, the processing efficiency can be improved, and by displaying the conversation simultaneously in the conversation list region and the sticky conversation region, flexibility in displaying the conversation can be improved, thereby facilitating the user's operations.

According to an embodiment of yet another aspect of the present disclosure, an electronic device is provided. The electronic device includes a processor and a memory. The processor executes a program corresponding to executable program codes stored in the memory by reading the executable program codes, to perform the method for sticking a conversation message on top for processing as described in the above one aspect.

According to an embodiment of still yet another aspect of the present disclosure, a computer-readable storage medium is provided. The computer-readable storage medium has a computer program stored thereon. The program, when executed by a processor, implements the method for sticking a conversation message on top for processing as described in the above one aspect.

Additional aspects and advantages of the present disclosure will be given at least in part in the following description, or become apparent at least in part from the following description, or can be learned from practicing of the present disclosure.

### BRIEF DESCRIPTION OF DRAWINGS

The above and/or additional aspects and advantages of the present disclosure will become more apparent and more understandable from the following description of embodiments taken in conjunction with the accompanying drawings, in which:

FIG. 1 is a flowchart illustrating a method for sticking a conversation message on top for processing according to an embodiment of the present disclosure;

FIG. 2 is a flowchart illustrating a method for sticking a conversation message on top for processing according to another embodiment of the present disclosure;

FIG. 3 is a flowchart illustrating a method for sticking a conversation message on top for processing according to yet another embodiment of the present disclosure;

FIG. 4 is a flowchart illustrating a method for sticking a conversation message on top for processing according to still yet another embodiment of the present disclosure;

FIG. 5 is a flowchart illustrating a method for sticking a conversation message on top for processing according to still yet another embodiment of the present disclosure;

FIG. 6 is a first schematic diagram showing a display interface of a client according to an embodiment of the present disclosure;

FIG. 7 is a second schematic diagram showing a display interface of a client according to an embodiment of the present disclosure;

FIG. 8 is a block diagram showing a structure of an apparatus for sticking a conversation message on top for processing according to an embodiment of the present disclosure;

FIG. 9 is a block diagram showing a structure of an electronic device suitable for implementing an embodiment of the present disclosure; and

FIG. 10 is a schematic diagram showing a computer-readable storage medium according to an embodiment of the present disclosure.

### DESCRIPTION OF EMBODIMENTS

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

A method and apparatus for sticking a conversation message on top for processing according to the embodiments of the present disclosure will be described below with reference to the figures.

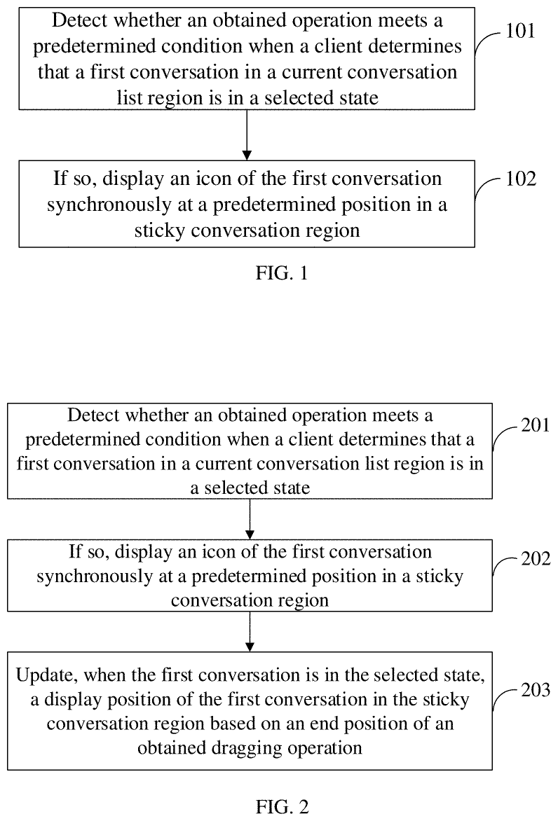

FIG. 1 is a flowchart illustrating a method for sticking a conversation message on top for processing according to an embodiment of the present disclosure.

As illustrated in FIG. 1, the method for sticking the conversation message on top for processing includes the following steps.

At step 101, when a client determines that a first conversation in a current conversation list region is in a selected state, it is detected whether an obtained operation meets a predetermined condition.

The client may be an instant messaging application, and conversations may be displayed in a form of a list in the conversation list region. A conversation list may be displayed in a reverse chronological order based on receiving time of the latest message in each conversation, or may be displayed in a predetermined order based on, for example, a number of messages in each conversation, a degree of activity of each conversation, etc., and this embodiment is not limited to any of these examples.

A user performs an operation on the first conversation in the conversation list region to select the first conversation, such as selecting the first conversation by clicking, or touching the first conversation with a finger, etc. When determining that the first conversation is in the selected state, the client detects whether the obtained operation meets the predetermined condition.

The predetermined condition may be, for example, a sticky conversation option in a conversation processing menu being selected, an end position the first conversation is dragged to being located in a sticky conversation region, and so on.

For example, the conversation processing menu may include the sticky conversation option, a mark completion option, etc. When the first conversation is in the selected state, it may be detected whether the sticky conversation option in the currently displayed conversation processing menu is selected. As another example, if the client detects a dragging operation of dragging the first conversation in the conversation list region, it may be detected whether an end position of the dragging operation is located in the sticky conversation region.

At step 102, if so, an icon of the first conversation is displayed synchronously at a predetermined position in a sticky conversation region.

In a case where the first conversation in the conversation list region is in the selected state, if it is detected that the obtained operation meets the predetermined condition, e.g., by determining whether the sticky conversation option in the currently displayed conversation processing menu is selected, or whether the end position of the dragging operation on the first conversation is located in the sticky conversation region, the icon of the first conversation is displayed synchronously at the predetermined position in the sticky conversation region.

For example, the first conversation may be displayed at a position adjacent to a position of the latest sticky conversation in the sticky conversation region. As another example, it may be set that at most three icons of conversations may be displayed in each line of the sticky conversation region, such that icons of sticky conversations may be displayed at predetermined positions in the sticky conversation region line by line from top to bottom.

In an embodiment, while the first conversation is being displayed in the sticky conversation region in a form of an icon, the first conversation is also being displayed in the conversation list region, which not only allows the user to process conversation messages based on icons in the sticky conversation region, but also improves flexibility in displaying conversations, thereby facilitating the user's operations.

In the related art, sticky conversations are usually displayed in a form of a list. In an embodiment of the present disclosure, displaying an icon of a sticky conversation in the sticky conversation region may not only facilitate finding a conversation quickly based on its icon by the user, but also save space on an interface. When there may be a number of sticky conversations, more conversations may be displayed on an interface of a certain size with the method according to this embodiment.

In an embodiment of the present disclosure, before displaying the icon of the first conversation synchronously at the predetermined position in the sticky conversation region, the predetermined position may be determined as follows.

As a possible implementation, icons of sticky conversations can be displayed in the sticky conversation region in sequence based on display positions and time of being stuck on top of the sticky conversations. In this case, when the first conversation is displayed in the sticky conversation region, a display position of the icon of the first conversation may be determined based on a display position of each conversation in the current sticky conversation region. For example, a position of a predetermined size on a right side of the latest sticky conversation in the sticky conversation region can be determined as the predetermined position.

As another possible implementation, a conversation in the conversation list region can be dragged to the sticky conversation region through a dragging operation for sticking the conversation on top. Specifically, an end position of the dragging operation obtained may be determined as a predetermined position to display the icon of the first conversation at the predetermined position in the sticky conversation region.

In order to improve flexibility of displaying a sticky conversation, in an embodiment, a display position of a conversation in the sticky conversation region can be adjusted by a dragging operation. The following description will be given with reference to FIG. 2, which is a flowchart illustrating a method for sticking a conversation message on top for processing according to another embodiment of the present disclosure.

As illustrated in FIG. 2, the method for sticking the conversation message on top for processing includes the following steps.

At step 201, when a client determines that a first conversation in a current conversation list region is in a selected state, it is detected whether an obtained operation meets a predetermined condition.

At step 202, if so, an icon of the first conversation is displayed synchronously at a predetermined position in a sticky conversation region.

In this embodiment, steps 201-202 are similar to the above steps 101-102, and thus the description thereof will be omitted here.

At step 203, when the first conversation is in the selected state, a display position of the first conversation in the sticky conversation region is updated based on an end position of an obtained dragging operation.

The user can perform a selection operation at the display position of the first conversation, such as clicking a mouse or performing a touch operation at a position on a touch screen corresponding to the first conversation, and drag the first conversation to another position in the sticky conversation region. Then, when the first conversation is in the selected state, the end position of the obtained dragging operation may be used as a new display position of the first conversation. Thus, the first conversation can be displayed at the end position of the dragging operation, such that the display position of the first conversation in sticky conversation region can be updated.

With the method for sticking the conversation message on top for processing according to the embodiment of the present disclosure, the user can adjust the display position of each conversation in the sticky conversation region through the dragging operation, which not only meets personalized needs of the user, but also improves flexibility in displaying each conversation in the sticky conversation region.

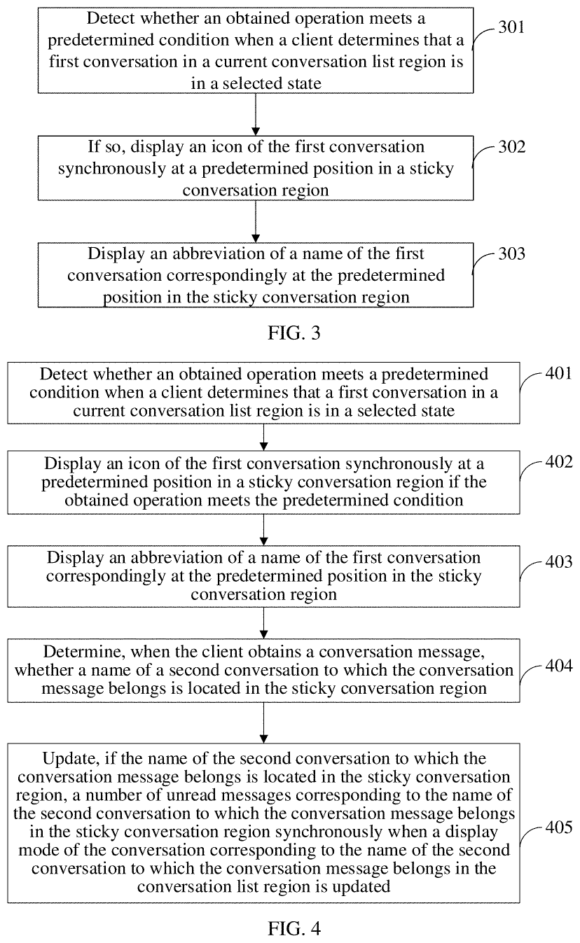

When there are a number of conversations in the sticky conversation region, if only icons of the conversations are displayed in the sticky conversation region, it is not convenient for the user to find the conversation he/she is looking for. In an embodiment, an abbreviation of a name of each conversation, such as an abbreviation of a group name, may also be displayed in the sticky conversation region. The following description will be given with reference to FIG. 3, which is a flowchart illustrating a method for sticking a conversation message on top for processing according to yet another embodiment of the present disclosure.

As illustrated in FIG. 3, the method for sticking the conversation message on top for processing includes the following steps.

At step 301, when a client determines that a first conversation in a current conversation list region is in a selected state, it is detected whether an obtained operation meets a predetermined condition.

At step 302, if so, an icon of the first conversation is displayed synchronously at a predetermined position in a sticky conversation region.

In this embodiment, steps 301-302 are similar to the above steps 101-102, and thus the description thereof will be omitted here.

At step 303, an abbreviation of a name of the first conversation is displayed correspondingly at the predetermined position in the sticky conversation region.

After the icon of the first conversation is displayed synchronously at the predetermined position in the sticky conversation region, the abbreviation of the name of the first conversation may be displayed correspondingly at the predetermined position in the sticky conversation region. For example, the abbreviation of the name of the first conversation may be displayed right below the icon of the first conversation. For another example, a name of a sender of the conversation message of the first conversation may be displayed below the icon of the first conversation.

In an embodiment of the present disclosure, by simultaneously displaying an icon and an abbreviation of a name of a sticky conversation in the sticky conversation region, the user can quickly find the conversation in the sticky conversation region based on the icon and the abbreviation of the name of the conversation.

In practical applications, through an abbreviation of a name of a conversation, it may not be easy for the user to identify whether it is the conversation he/she is looking for. Further, after the abbreviation of the name of the first conversation is displayed correspondingly at the predetermined position in the sticky conversation region, the name corresponding to the first conversation can be displayed in full at the icon of the first conversation when the client detects that a current position of a focus matches the predetermined position.

For example, when the user puts the mouse on a display position of a conversation in the sticky conversation region, or touches the display position of the conversation, a full name corresponding to the conversation may be displayed at the icon of the conversation in a floating manner. When the user moves the mouse to another position, the full name of the conversation displayed in the floating manner may disappear.

In an embodiment of the present disclosure, when the client detects that the position of the focus is at a display position of a conversation in the sticky conversation region, the full name of the conversation can be displayed at the icon of the conversation, so that it is convenient for the user to learn the name of the conversation, and the efficiency in processing conversation messages can be improved.

In practical applications, the client may continuously receive new conversation messages after being activated. In an embodiment of the present disclosure, a conversation may be updated according to a method illustrated in FIG. 4. FIG. 4 is a flowchart illustrating a method for sticking a conversation message on top for processing according to still yet another embodiment of the present disclosure.

As illustrated in FIG. 4, the method for sticking the conversation message on top for processing includes the following steps.

At step 401, when a client determines that a first conversation in a current conversation list region is in a selected state, it is detected whether an obtained operation meets a predetermined condition.

At step 402, if the obtained operation meets the predetermined condition, an icon of the first conversation is displayed synchronously at a predetermined position in a sticky conversation region.

In this embodiment, steps 401-402 are similar to the above steps 101-102, and thus the description thereof will be omitted here.

At step 403, an abbreviation of a name of the first conversation is displayed correspondingly at the predetermined position in the sticky conversation region.

After the icon of the first conversation is displayed synchronously at the predetermined position in the sticky conversation region, the abbreviation of the name of the first conversation may be displayed correspondingly at the predetermined position in the sticky conversation region. For example, the abbreviation of the name of the conversation may be displayed right below the icon of the conversation.

At step 404, when the client obtains a conversation message, it is determined whether a name of a second conversation to which the conversation message belongs is located in the sticky conversation region.

When the client is running, new conversation messages may be continuously received. Each conversation message may carry a user identifier of a sender of the conversation message, sending time, and so on.

When the client obtains a conversation message, a name of a second conversation to which the conversation message belongs can be determined based on a user identifier of a sender who sent the conversation message, and then it can be determined whether the name of the second conversation to which the conversation message belongs is in the sticky conversation region based on the name of the second conversation to which the conversation message belongs. That is, when the client obtains the conversation message, it is determined whether the conversation to which the conversation message belongs is located in the sticky conversation region based on the name of the conversation to which the conversation message belongs.

At step 405, if the name of the second conversation to which the conversation message belongs is located in the sticky conversation region, a number of unread messages corresponding to the name of the second conversation to which the conversation message belongs in the sticky conversation region can be synchronously updated when a display mode of the conversation corresponding to the name of the second conversation to which the conversation message belongs in the conversation list region is updated.

Since any conversation in the sticky conversation region is displayed synchronously in the conversation list region, if a name of a second conversation to which a conversation message obtained belongs is located in the sticky conversation region, the second conversation to which the conversation message belongs in the conversation list region and the second conversation to which the conversation message belongs in the sticky conversation region can be updated synchronously.

Specifically, when the display mode of the conversation corresponding to the name of the second conversation to which the conversation message belongs in the conversation list region is updated, e.g., when display content, a number of unread messages, etc., are updated, the number of unread messages corresponding to the name of the second conversation to which the conversation message belongs in the sticky conversation region can be synchronously updated. A numeral can be used to identify the number of unread messages. The numeral can be displayed at a defined position of an icon of a second conversation, such as an upper right portion.

For example, if a number of unread messages corresponding to a name of a conversation in the sticky conversation region is ten, when a new conversation message for the conversation is received, display content of the conversation in the conversation list region can be updated to content of the new conversation message, and the number of unread messages corresponding to the conversation in the sticky conversation region can be updated to eleven.

In an embodiment of the present disclosure, when the client receives a conversation message, synchronously updating a display mode of the conversation to which the conversation message belongs in the conversation list region and a number of unread messages corresponding to the conversation in the sticky conversation region may ensure synchronized updating of information of the same conversation in the conversation list region and the sticky conversation region. Moreover, the number of unread messages can be displayed on each conversation in the sticky conversation region, such that the user can be aware of the situation of unprocessed conversation messages.

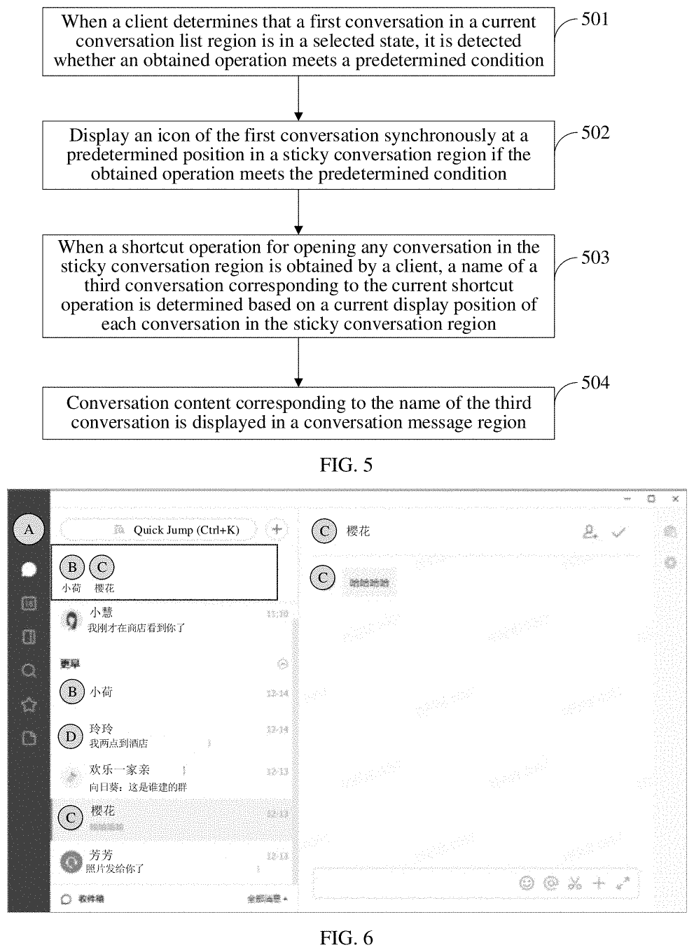

In practical applications, a conversation in the sticky conversation region can be opened by a mouse click or touch operation, but such operations are relatively troublesome and will affect efficiency in processing conversation messages. In an embodiment of the present disclosure, any conversation in the sticky conversation region may be opened through a shortcut operation, which is described below with reference to FIG. 5. FIG. 5 is a flowchart illustrating a method for sticking a conversation message on top for processing according to still yet another embodiment of the present disclosure.

As illustrated in FIG. 5, the method for sticking the conversation message on top for processing includes the following steps.

At step 501, when a client determines that a first conversation in a current conversation list region is in a selected state, it is detected whether an obtained operation meets a predetermined condition.

At step 502, if the obtained operation meets the predetermined condition, an icon of the first conversation is displayed synchronously at a predetermined position in a sticky conversation region.

In this embodiment, steps 501-502 are similar to the above steps 101-102, and thus the description thereof will be omitted here.

At step 503, when a shortcut operation for opening any conversation in the sticky conversation region is obtained by a client, a name of a third conversation corresponding to the current shortcut operation is determined based on a current display position of each conversation in the sticky conversation region.

In this embodiment, any conversation in the sticky conversation region can be opened through the shortcut operation. Specifically, when obtaining an operation by the user, the client can analyze the operation. When it is determined that the operation is the shortcut operation for opening any conversation in the sticky conversation region, a display position of the second conversation corresponding to the shortcut operation can be determined based on the current display position of each conversation in the sticky conversation region, and then the name of the third conversation can be determined.

As an example, the shortcut operation for opening any conversation in the sticky conversation region can be set as “Ctrl+display position of conversation”. Here the display position of the conversation can be represented by a numeral. When the shortcut operation for opening any conversation in the sticky conversation region is obtained, a conversation corresponding to the numeral in the shortcut operation may be found from the sticky conversation region based on the numeral indicating the display position of the conversation in the shortcut operation and the current display position of each conversation in the sticky conversation region. The name of the conversation is the name of the third conversation corresponding to the shortcut operation.

For example, a keyboard shortcut “Ctrl+1” may open the first conversation in the sticky conversation region, a keyboard shortcut “Ctrl+2” may open the second conversation in the sticky conversation region, and a keyboard shortcut “Ctrl+3” may open the third conversation in the sticky conversation region, and so on.

At step 504, conversation content corresponding to the name of the third conversation is displayed in a conversation message region.

After the name of the third conversation corresponding to the shortcut operation is determined, the conversation content corresponding to the name of the second conversation can be displayed in the conversation message region, so that the user can process conversations in the conversation message region.

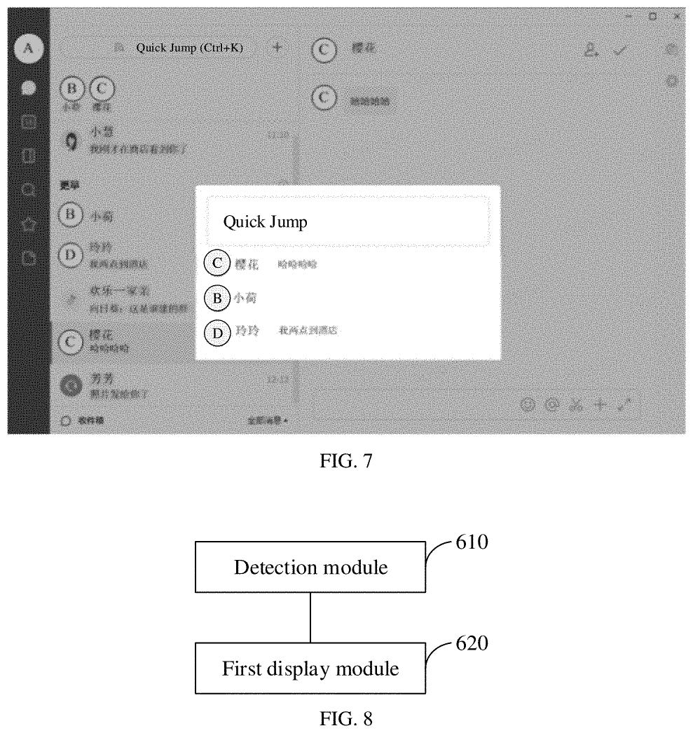

Reference is now made to FIG. 6 and FIG. 7. FIG. 6 is a first schematic diagram showing a display interface of a client according to an embodiment of the present disclosure. FIG. 7 is a second schematic diagram showing a display interface of a client according to an embodiment of the present disclosure.

In FIG. 6, the conversation message region is shown on a right side of the display interface, and the sticky conversation region is shown as a region marked with a box on an upper left part of the display interface. The sticky conversation region includes icons of two sticky conversations. The second conversation in the sticky conversation region can be opened by a keyboard shortcut “Ctrl+2”. As illustrated in FIG. 6, the second conversation is displayed in the conversation message region, and the second conversation is in the selected state in the conversation list region.

In addition, the user clicks a “Quick Jump” button in the sticky conversation region in FIG. 6, or uses a shortcut operation “Ctrl+k” to open a jump entry. The jump entry pops up on an interface of the client, as illustrated in FIG. 7. In FIG. 7, a jump list is displayed below the jump entry. In addition to directly searching for a conversation to be opened in the jump entry, an important conversation can be displayed in the jump list with a high priority. The user can select a conversation to open from the jump list.

In an embodiment of the present disclosure, when the client obtains the shortcut operation for opening any conversation in the sticky conversation region, the client can quickly open a corresponding conversation based on the current display position of each conversation in the sticky conversation region, thereby improving efficiency in processing conversation messages by the user.

To implement the above embodiments, an embodiment of the present disclosure further provides an apparatus for sticking a conversation message on top for processing. FIG. 8 is a block diagram showing a structure of an apparatus for sticking a conversation message on top for processing according to an embodiment of the present disclosure.

As illustrated in FIG. 8, the apparatus for sticking the conversation message on top for processing includes a detection module 610 and a first display module 620.

The detection module 610 is configured to detect whether an obtained operation meets a predetermined condition when a client determines that a first conversation in a current conversation list region is in a selected state.

The first display module 620 is configured to display an icon of the first conversation synchronously at a predetermined position in a sticky conversation region when the obtained operation meets the predetermined condition.

In an embodiment of the present disclosure, the detection module 610 can be configured to detect whether a sticky conversation option in a conversation processing menu currently displayed is selected; or, detect whether an end position of a dragging operation obtained currently is located in the sticky conversation region.

In an embodiment of the present disclosure, the apparatus can further include a first determining module and a second determining module. The first determining module is configured to determine the predetermined position based on a current display position of each conversation in the sticky conversation region. The second determining module is configured to determine the predetermined position based on the end position of the obtained dragging operation.

In an embodiment of the present disclosure, the apparatus can further include a first updating module. The first updating module is configured to update, when the first conversation is in the selected state, a display position of the first conversation in the sticky conversation region based on an end position of an obtained dragging operation.

In an embodiment of the present disclosure, the first display module 620 can be further configured to display an abbreviation of a name of the first conversation correspondingly at the predetermined position in the sticky conversation region.

In an embodiment of the present disclosure, the apparatus can further include a determination module and a second updating module. The determination module is configured to determine, when the client obtains a conversation message, whether a name of a second conversation to which the conversation message belongs is located in the sticky conversation region. The second updating module is configured to synchronously update, if the name of the second conversation to which the conversation message belongs is located in the sticky conversation region, a number of unread messages corresponding to the name of the second conversation to which the conversation message belongs in the sticky conversation region when a display mode of the conversation corresponding to the name of the second conversation to which the conversation message belongs in the conversation list region is updated.

In an embodiment of the present disclosure, the first display module 620 can be further configured to display, when the client detects that a current position of a focus matches the predetermined position, the name corresponding to the first conversation in full at the icon of the first conversation.

In an embodiment of the present disclosure, the apparatus can further include a determining module and a second display module. The determining module is configured to determine, when a shortcut operation for opening any conversation in the sticky conversation region is obtained, a name of a third conversation corresponding to the current shortcut operation based on the current display position of each conversation in the sticky conversation region. The second display module is configured to display conversation content corresponding to the name of the third conversation in a conversation message region.

It is to be noted that the above description of the embodiments of the method for sticking the conversation message on top for processing is also applicable to the apparatus for sticking the conversation message on top for processing according to the embodiment, and thus details thereof will be omitted here.

With the apparatus for sticking the conversation message on top for processing according to the embodiment of the present disclosure, when a client determines that a first conversation in a current conversation list region is in a selected state, it is detected whether an obtained operation meets a predetermined condition. If so, an icon of the first conversation is displayed synchronously at a predetermined position in a sticky conversation region. In this way, an icon of a conversation in a conversation list region can be displayed synchronously in the sticky conversation region through an operation meeting the predetermined condition, such that a user can process a message based on the icon in the sticky conversation region. In this way, the processing efficiency can be improved, and by displaying the conversation simultaneously in the conversation list region and the sticky conversation region, flexibility in displaying the conversation can be improved, thereby facilitating the user's operations.

To implement the above embodiments, an embodiment of the present disclosure further provides an electronic device. The electronic device includes a processor and a memory. The processor executes a program corresponding to executable program codes by reading the executable program codes stored in the memory, to perform the method for sticking the conversation message on top for processing as described in the above embodiments.

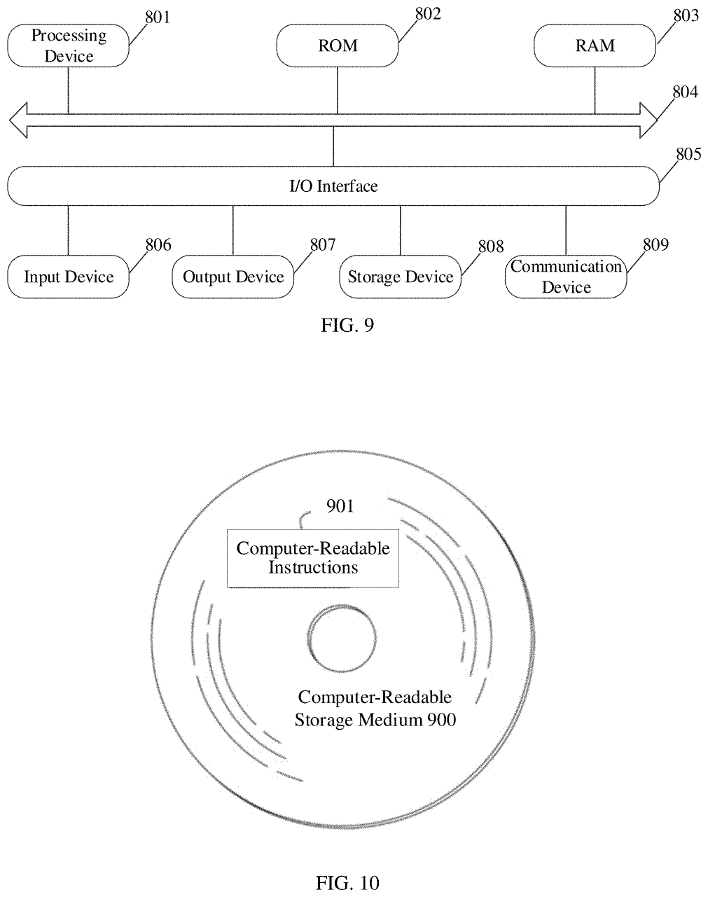

Reference is now made to FIG. 9, which is a block diagram showing a structure of an electronic device 800 suitable for implementing an embodiment of the present disclosure. A terminal device according to the embodiment of the present disclosure may include, but not limited to, a mobile terminal such as a mobile phone, a laptop computer, a digital broadcast receiver, a Personal Digital Assistant (PDA), a tablet computer or PAD, a Portable Multimedia Player (PMP), or a vehicle-mounted terminal (e.g., a vehicle-mounted navigation terminal), or a fixed terminal such as a digital TV, a desktop computer, etc. The electronic device illustrated in FIG. 9 is exemplary only, and should not be construed as limiting the function and scope of use of the embodiments of the present disclosure.

As illustrated in FIG. 9, the electronic device 800 may include a processing device (such as a central processing unit, a graphics processing unit, etc.) 801, which may perform various appropriate actions and processes in accordance with programs stored in a Read Only Memory (ROM) 802 or loaded from a storage device 808 into a Random Access Memory (RAM) 803. In the RAM 803, various programs and data required for operation of the electronic device 800 may also be stored. The processing device 801, the ROM 802, and the RAM 803 are connected to each other through a bus 804. An Input/Output (I/O) interface 805 is also connected to the bus 804.

Generally, the following devices may be connected to the I/O interface 805: an input device 806 including, for example, a touch screen, a touch pad, a keyboard, a mouse, a camera, a microphone, an accelerometer, a gyroscope, etc.; an output device 807 including, for example, a Liquid Crystal Display (LCD), a speaker, an oscillator, etc.; the storage device 808 including, for example, a magnetic tape or a hard disk; and a communication device 809. The communication device 809 may allow the electronic device 800 to perform wireless or wired communication with other devices for data exchange. Although FIG. 9 illustrates the electronic device 800 having various devices, it can be appreciated that it is not necessary to implement or provide all the illustrated devices. Alternatively, more or fewer devices may be implemented or provided.

In particular, according to an embodiment of the present disclosure, the processes described above with reference to the flowcharts may be implemented as computer software programs. For example, an embodiment of the present disclosure includes a computer program product, which includes a computer program carried on a computer-readable medium. The computer program includes program codes for implementing the method illustrated in any of the flowcharts. In these embodiments, the computer program may be downloaded and installed from a network through the communication device 809, or installed from the storage device 808, or installed from the ROM 802. When the computer program is executed by the processing device 801, the above-mentioned functions defined in the methods according to the embodiments of the present disclosure are performed.

It is to be noted that the above computer-readable medium in the present disclosure may be a computer-readable signal medium or a computer-readable storage medium or any combination thereof. The computer-readable storage medium may be, but not limited to, for example, an electrical, magnetic, optical, electromagnetic, infrared, or semiconductor system, apparatus, or device, or any combination thereof. More specific examples of the computer-readable storage medium may include, but not limited to: an electrical connection having one or more wires, a portable computer disk, a hard disk, a Random Access Memory (RAM), a Read Only Memory (ROM), an Erasable Programmable Read Only Memory (EPROM) or a flash memory, an optical fiber, a Compact Disc Read-Only Memory (CD-ROM), an optical memory device, a magnetic memory device, or any suitable combination thereof. In the present disclosure, the computer-readable storage medium may be any tangible medium including or storing programs, which may be used by or used with an instruction execution system, apparatus, or device. However, in the present disclosure, the computer-readable signal medium may include a data signal propagated in a baseband or as a part of a carrier that carries computer-readable program codes. Such propagated data signal may be in various forms, including but not limited to an electromagnetic signal, an optical signal, or any suitable combination thereof. The computer-readable signal medium may be any computer-readable medium other than the computer-readable storage medium, which may transmit, propagate, or transfer programs used by or used with an instruction execution system, apparatus or device. The program codes contained on the computer-readable medium may be transmitted via any appropriate medium, including but not limited to electric cable, optical cable, Radio Frequency (RF), or any suitable combination thereof.

The above computer-readable medium may be included in the above electronic device; or may be standalone without being assembled into the electronic device.

The above computer-readable medium may carry one or more programs which, when executed by the electronic device, cause the electronic device to: obtain at least two Internet Protocol addresses; send a node assessment request including the at least two Internet Protocol addresses to a node assessment device, in which the node assessment device selects an Internet Protocol address from the at least two Internet Protocol addresses and returns the Internet Protocol address; and receive the Internet Protocol address returned by the node assessment device. Each of the obtained Internet Protocol address indicates an edge node in a content distribution network.

Alternatively, the above computer-readable medium may carry one or more programs which, when executed by the electronic device, cause the electronic device to: obtain at least two Internet Protocol addresses; send a node assessment request including the at least two Internet Protocol addresses to a node assessment device, in which the node assessment device selects an Internet Protocol address from the at least two Internet Protocol addresses and returns the Internet Protocol address; and receive the Internet Protocol address returned by the node assessment device. Each of the obtained Internet Protocol address indicates an edge node in a content distribution network.

The computer program codes for implementing the operations according to the embodiments of the present disclosure may be written in one or more programming languages or any combination thereof. The programming languages may include object-oriented programming languages, such as Java, Smalltalk, or C++, as well as conventional procedure-oriented programming languages, such as “C” language or similar programming languages. The program codes may be executed completely on a user computer, partly on the user computer, as a standalone software package, partly on the user computer and partly on a remote computer, or completely on the remote computer or server. In a case where the remote computer is involved, the remote computer may be connected to the user computer through any types of network, including a Local Area Network (LAN) or a Wide Area Network (WAN), or to an external computer (e.g., over the Internet by using an Internet service provider).

The flowcharts and block diagrams in the figures illustrate architectures, functions, and operations of possible implementations of systems, methods, and computer program products according to various embodiments of the present disclosure. In this regard, each block in the flowcharts or block diagrams may represent a module, a program segment, or a part of codes. The module, program segment, or part of codes may contain one or more executable instructions for implementing a specified logical function. It is also to be noted that, in some alternative implementations, functions showed in blocks may occur in a different order from the order shown in the figures. For example, two blocks illustrated in succession may actually be executed substantially in parallel with each other, or sometimes even in a reverse order, depending on functions involved. It is also to be noted that each block in the block diagrams and/or flowcharts, or any combination of the blocks in the block diagrams and/or flowcharts, may be implemented using a dedicated hardware-based system that is configured to perform specified functions or operations or using a combination of dedicated hardware and computer instructions.

Units involved and described in the embodiments of the present disclosure may be implemented in software or hardware. A name of a unit does not constitute a limitation on the unit itself under certain circumstances. For example, a first obtaining unit may also be described as “a unit for obtaining at least two Internet Protocol addresses”.

To implement the above embodiments, an embodiment of the present disclosure provides a computer-readable storage medium. The computer-readable storage medium stores a computer program. The computer program, when executed by a processor, implements the method for sticking the conversation message on top for processing as described in the above embodiments.

FIG. 10 is a schematic diagram showing a computer-readable storage medium according to an embodiment of the present disclosure. As illustrated in FIG. 10, a computer-readable storage medium 900 according to the embodiment of the present disclosure has computer-readable instructions 901 stored thereon. The computer-readable instructions 901, when executed by a processor, implements all or part of the steps of the method for sticking the conversation message on top for processing according to the above embodiments of the present disclosure.

In the description of the present disclosure, the terms “first” and “second” are only used for the purpose of description, and should not be construed as indicating or implying any relative importance or implicitly indicating the number of defined technical features. Therefore, the features defined with “first” and “second” may explicitly or implicitly include at least one of the features. In the description of the present disclosure, “a plurality of” means at least two, e.g., two, three, etc., unless specifically defined otherwise.

Although the embodiments of the present disclosure have been shown and described above, it can be appreciated that the above embodiments are exemplary only, and should not be construed as limiting the present disclosure. Various changes, modifications, replacements and variants can be made to the above embodiments by those skilled in the art without departing from the scope of the present disclosure.

What is claimed is:

1. A method for sticking a conversation message on top for processing, comprising:
detecting whether an operation on a first conversation in a conversation list region meets a predetermined condition, wherein conversations are displayed in a form of a list in the conversation list region;
if so, displaying an icon of the first conversation synchronously at a predetermined position in a sticky conversation region, while keeping the first conversation displayed in the conversation list region; and
displaying, in response to a triggering operation on the icon of the first conversation in the sticky conversation region, a window of the first conversation.

2. The method of claim 1, wherein said detecting whether the operation on the first conversation in the conversation list region meets the predetermined condition comprises:
detecting, when the first conversation in the conversation list region is in a selected state, whether a sticky conversation option in a conversation processing menu currently displayed is selected;
or,
detecting, when the first conversation in the conversation list region is in a selected state, whether an end position of a dragging operation obtained currently is located in the sticky conversation region.

3. The method of claim 2, further comprising, prior to said displaying the icon of the first conversation synchronously at the predetermined position in the sticky conversation region:
determining the predetermined position based on a current display position an icon of each conversation in the sticky conversation region;
or,
determining the predetermined position based on the end position of the obtained dragging operation.

4. The method of claim 1, further comprising, subsequent to said displaying the icon of the first conversation synchronously at the predetermined position in the sticky conversation region:
updating, when the first conversation is in the selected state, a display position of the first conversation in the sticky conversation region based on an end position of an obtained dragging operation.

5. The method of claim 1, wherein said displaying the icon of the first conversation synchronously at the predetermined position in the sticky conversation region comprises:
displaying an abbreviation of a name of the first conversation correspondingly at the predetermined position in the sticky conversation region.

6. The method of claim 5, further comprising, subsequent to said displaying the abbreviation of the name of the first conversation correspondingly at the predetermined position in the sticky conversation region:
determining, in response to obtaining the conversation message, whether a second conversation to which the conversation message belongs is located in the sticky conversation region; and
if so, synchronously updating the number of unread messages corresponding to the icon of the second conversation in the sticky conversation region when a display mode of an icon of a conversation corresponding to the second conversation in the conversation list region is updated.

7. The method of claim 5, further comprising, subsequent to said displaying the abbreviation of the name of the first conversation correspondingly at the predetermined position in the sticky conversation region:
displaying, when it is detected that a current position of a focus matches the predetermined position, the name corresponding to the first conversation in full at the icon of the first conversation.

8. The method of claim 1, further comprising, subsequent to said displaying the icon of the first conversation synchronously at the predetermined position in the sticky conversation region:
determining, when a shortcut operation for opening any conversation in the sticky conversation region is obtained, a third conversation corresponding to the current shortcut operation based on a current display position of an icon of each conversation in the sticky conversation region; and
displaying a conversation window corresponding to the third conversation in a conversation message region.

9. The method of claim 1, wherein the sticky conversation region is provided with a jump component;
displaying, in response to a trigger operation on the jump component, a jump window comprising a search component and/or identification information of conversations; and
displaying, in response to a selection operation on identification information of one of the conversations, a conversion window corresponding to the identification information of the conversation; or
displaying, in response to inputting content in the search component, information associated with the input content.

10. The method of claim 9, further comprising:
determining a display priority of the identification information of the conversation in the jump window based on a relevancy degree of the conversation corresponding to the identification information of the conversation.

11. The method of claim 1, wherein said displaying the icon of the first conversation synchronously at the predetermined position in the sticky conversation region comprises:
displaying icons of sticky conversations in the sticky conversation region in sequence based on time of the icons of the sticky conversations being stuck on top, or display positions and time of the icons of the sticky conversations being stuck on top.

12. The method of claim 1, wherein said displaying the icon of the first conversation synchronously at the predetermined position in the sticky conversation region comprises:
displaying the icon of the first conversation at a position adjacent to a position of an icon of the latest sticky conversation in the sticky conversation region.

13. The method of claim 1, further comprising:
displaying icons of sticky conversations in the sticky conversation region line by line from top to bottom in sequence based on the number of icons of conversations that each row in the sticky conversation region is capable of receiving.

14. The method of claim 1, wherein said triggering operation on the icon of the first conversation comprises: a click operation or a touch operation on the icon of the first conversation.

15. The method of claim 1, wherein said displaying, in response to the triggering operation on the icon of the first conversation in the sticky conversation region, the window of the first conversation comprises:
displaying the window of the first conversation and the sticky conversation region in a display interface.

16. The method of claim 1, wherein the sticky conversation region is configured to display identification information of sticky conversations or unread message information, and wherein information of the sticky conversations displayed in the sticky conversation region comprises partial information of information of the sticky conversations displayed in the conversations list region.

17. A method for sticking a conversation message on top for processing, comprising
detecting whether an operation on a first conversation in a conversation list region meets a predetermined condition, wherein conversations are displayed in a form of a list in the conversation list region; and
if so, displaying an icon of the first conversation synchronously at a predetermined position in a sticky conversation region, while keeping the first conversation displayed in the conversation list region,
wherein a space of an interface occupied by the first conversation in the sticky conversation region is smaller than a space of an interface occupied by the first conversation in the conversation list region.

18. The method of claim 17, further comprising:
displaying unread message information of sticky conversations in the sticky conversation region.

19. The method of claim 17, wherein the sticky conversation region is configured to display the icon and other identification information of the first conversation.

20. The method of claim 17, wherein information of sticky conversations displayed in the sticky conversation region comprises partial information of information of the sticky conversations displayed in the conversations list region.

21. An electronic device, comprising a processor and a memory,
wherein the processor executes a program corresponding to executable program codes stored in the memory by reading the executable program codes, to perform the method for sticking a conversation message on top for processing according to claim 1.

22. An electronic device, comprising a processor and a memory,
wherein the processor executes a program corresponding to executable program codes stored in the memory by reading the executable program codes, to perform the method for sticking a conversation message on top for processing according to claim 17.

23. A computer-readable storage medium having a computer program stored thereon, wherein the program, when executed by a processor, implements the method for sticking a conversation message on top for processing according to claim 1.

24. A computer-readable storage medium having a computer program stored thereon, wherein the program, when executed by a processor, implements the method for sticking a conversation message on top for processing according to claim 17.
